(19) United States
(12) Patent Application Publication
(10) Pub. No.: US 2025/0081878 A1
(43) Pub. Date: Mar. 13, 2025

(54) AGRICULTURAL PRODUCT DISTRIBUTION DEVICE

(71) Applicant: KUHN SAS, Saverne (FR)

(72) Inventor: Olivier CONSTANT, Weiterswiller (FR)

(73) Assignee: KUHN SAS, Saverne (FR)

(21) Appl. No.: 18/829,406

(22) Filed: Sep. 10, 2024

(30) Foreign Application Priority Data
Sep. 11, 2023 (FR) 2309518

(51) Int. Cl. A01C 7/08; A01C 7/04

(52) U.S. Cl. CPC A01C 7/082; A01C 7/046

(57) ABSTRACT

[Seed distribution device for an agricultural machine with a housing, a seed inlet, a perforated disc driven to transport the seeds and an outlet tube, the seeds being transported from a tank to the outlet tube by means of an air pressure difference, the air pressure difference being interrupted so that the seeds leave the disc to reach the outlet tube, the outlet tube comprising a first portion into which the seeds enter via an inlet, this first portion of the outlet tube being located inside the housing and being oriented so that the inlet is adjacent to the disc; the distribution device comprises a fairing element in which a first opening extending along a first fairing plane is carried out, and the fairing element covers the first portion of the outlet tube.

### BACKGROUND OF THE INVENTION

### Field of the Invention

The present invention relates to the technical field of agricultural machinery, and in particular agricultural seeders.

The invention relates more specifically to a seed distribution device, for an agricultural machine such as a single seeder, the distribution device comprising a housing, a seed inlet arranged in the housing, a perforated disc driven to transport the seeds along a circular path, an outlet tube transporting the seeds from the housing to a furrow in a plot of land, the seeds being transported from a tank located in the housing to the outlet tube by means of an air pressure difference on either side of the disc, the air pressure difference being interrupted in an outlet region close to the outlet tube, so that the seeds leave the disc to reach the outlet tube, the outlet tube comprising a first portion into which the seeds enter via an inlet, this first portion of the outlet tube being located inside the housing and being oriented so that the inlet is adjacent to the disc.

### Description of the Related Art

A distribution device of the type described above is known from the document EP 3329758 A1. On the distribution device of this document, a tube is mounted in a pressurized chamber located inside the distribution housing. The tube inlet is arranged close to the distribution disc. The upper portion of the tube includes its inlet. This tube inlet is located in an area where the pressure flows are decisive. The mere presence of the tube in the chamber can significantly disrupt these pressure flows. The tube's protuberance in the chamber creates turbulence, making optimal management of the flows difficult. During operation, some seeds do not reach or do not enter the disc outlet tube. They accumulate in the chamber and are not therefore deposited in the soil. These seeds get trapped between the tube and the pressurized chamber, disrupting the consistency of the distribution. A deterioration in pressure flows leads to a drop in consistency, and therefore in sowing quality.

### SUMMARY OF THE INVENTION

The purpose of the present invention is to reduce, or even eliminate, at least one of the drawbacks mentioned above.

To this end, its subject is a seed distribution device, for an agricultural machine such as a single seeder, the distribution device comprising a housing, a seed inlet arranged in the housing, a perforated disc driven to transport the seeds along a circular path, an outlet tube transporting the seeds from the housing to a furrow in a plot of land, the seeds being transported from a tank located in the housing to the outlet tube by means of an air pressure difference on either side of the disc, the air pressure difference being interrupted in an outlet region close to the outlet tube, so that the seeds leave the disc to reach the outlet tube, the outlet tube comprising a first portion into which the seeds enter via an inlet, this first portion of the outlet tube being located inside the housing and being oriented so that the inlet is adjacent to the disc, characterized in that the distribution device comprises a fairing element in which is carried out a first opening extending along a first fairing plane, and in that the fairing element at least partially covers the first portion of the outlet tube. Thanks to the fairing element at the tube, the seeds no longer get trapped in unfavorable locations in the housing. They fall back into the seed tank if they do not enter the tube at the disc outlet.

The invention also relates to an agricultural machine comprising this distribution device.

### BRIEF DESCRIPTION OF THE DRAWINGS

The invention will be better understood from the following description, which refers to a preferred embodiment given as a non-limiting example and explained with reference to the attached schematic drawings, in which:

FIG. 1 is a perspective view of a distribution device according to the preferred embodiment of the invention;

FIG. 2 is a perspective view from a different orientation of the distribution device shown in FIG. 1.

FIG. 3 is a front view of the distribution device shown in FIG. 1, on which some components have been hidden.

FIG. 4 is a detailed view of the distribution device shown in FIG. 1, on which some components have been hidden.

FIG. 5A is a detailed view from a different orientation of the distribution device shown in FIG. 1, on which some components have been hidden.

FIG. 5B is a detailed view from a different orientation of the distribution device shown in FIG. 1, according to another embodiment.

FIG. 5C is a detailed view from a different orientation of the distribution device shown in FIG. 1, according to another embodiment.

FIG. 6 is a detailed view of the distribution device shown in FIG. 1, on which some components have been hidden.

FIG. 7 is a detailed cross-sectional view of the distribution device shown in FIG. 1, on which some components have been hidden.

FIG. 8 is a detailed cross-sectional view from a different orientation of the distribution device shown in FIG. 1, on which some components have been hidden.

FIG. 9 is a view of an outlet tube alone.

FIG. 10 is a cross-sectional view of the outlet tube alone shown in FIG. 9.

FIG. 11A and FIG. 11B are two detailed views of a component of the distribution device of the invention.

FIG. 12 is an overall view of an agricultural machine, in this case a single seeder, which can include at least one distribution device according to the invention.

### DETAILED DESCRIPTION OF THE PREFERRED EMBODIMENTS

The invention concerns a seed distribution device (1), for an agricultural machine (2) such as a single seeder, the distribution device (1) comprising a housing (3), a seed inlet (4) arranged in the housing (3), a perforated disc (5) driven to transport the seeds along a circular path, an outlet tube (7) transporting the seeds from the housing (3) to a furrow in a plot of land, the seeds being transported from a tank (8) located in the housing (3) to the outlet tube (7) by means of an air pressure difference on either side of the disc (5), the air pressure difference being interrupted in an outlet region (18) close to the outlet tube (7), so that the seeds leave the disc (5) to reach the outlet tube (7), the outlet tube (7) comprising a first portion (9) into which the seeds enter via an inlet (10), this first portion (9) of the outlet tube (7) being located inside the housing (3) and being oriented so that the inlet (10) is adjacent to the disc (5), characterized in that the distribution device (1) comprises a fairing element (11) in which is carried out a first opening (21) extending along a first fairing plane (23), and in that the fairing element (11) at least partially covers the first portion (9) of the outlet tube (7).

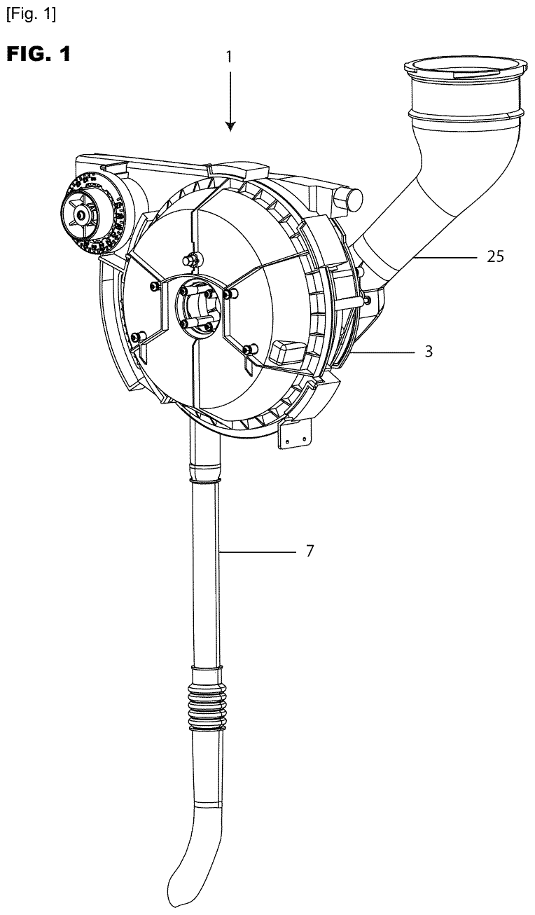

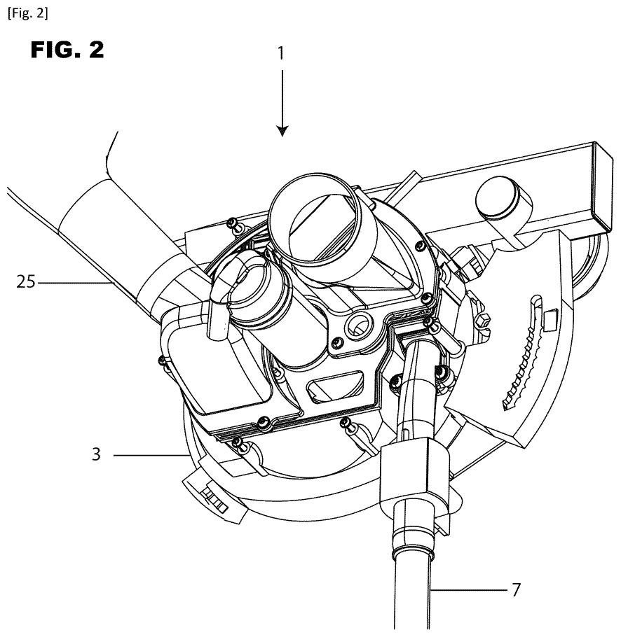

As shown in FIGS. 1 and 2, the distribution device (1) comprises the housing (3) to which the outlet tube (7) is connected. The outlet tube (7) makes it possible to transport the seeds dosed by the distribution device (1) to a furrow in a plot of land in a controlled manner and regularly.

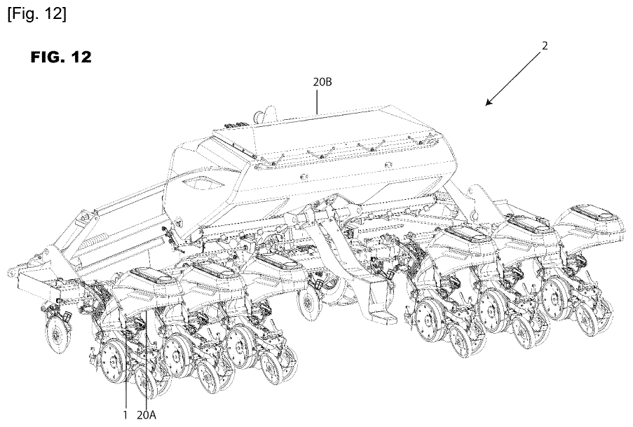

The seeds to be dosed by the distribution device (1) are initially stored in a seed hopper (20A), shown in FIG. 12.

It is also possible to dose particulate agricultural products other than seeds using the distribution device (1), for example granular fertilizer.

The agricultural product to be dosed can be fed to the distribution device (1) via a seed hopper (20A) located close to the distribution device (1), or via a fertilizer hopper (20B) remote from the distribution device (1). These two hoppers (20A; 20B) can be seen in FIG. 12. In a variant not shown, the seed hopper (20A) is remote from the distribution device (1). Similarly, in a variant not shown, the fertilizer hopper (20B) is located close to the distribution device (1).

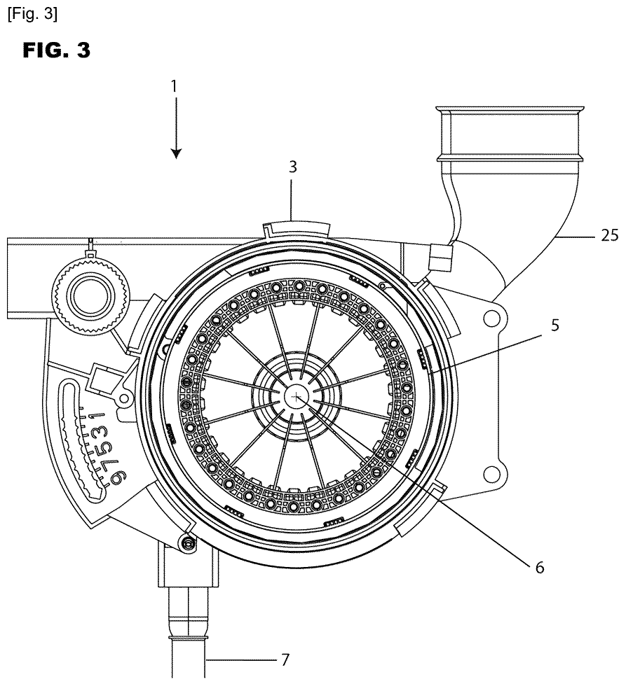

FIG. 3 shows the housing (3) of the distribution device (1) without its cover, revealing the disc (5). The disc (5) is mounted and driven in rotation inside the housing (3) around a swivel axis (6) and allows seeds to be transported along a circular path, with the help of drilling holes forming a circle concentric with the disc (5). The drilling holes extend around the circumference of the disc (5). In this way, each seed is selected by the disc (5) at the tank (8) and transported to the outlet tube (7) thanks to a pressure difference between the two faces of the disc (5).

The housing (3) consists of two removable parts, a housing base and a cover. The cover is attached to the housing base by rotation, for example by an eighth of a turn, in notches. Rotation to attach the cover takes place around an axis (not shown) parallel or coincident with the swivel axis (6) of the disc (5). Other lockable and removable attachment solutions are also possible, such as quarter-turn screws, or toggle-type fastening elements. Access to the elements inside the housing, such as the disc (5), is possible via the removable cover.

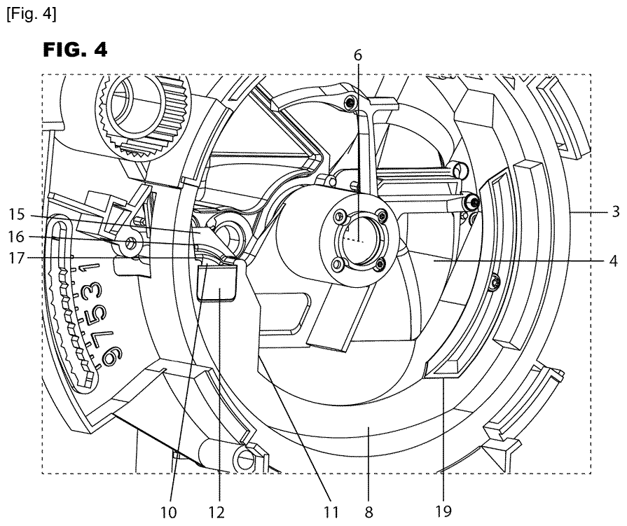

FIG. 4 shows a detailed view of the inside of the distribution device (1). The disc (5) has been removed to allow a view on the seed inlet (4) into the housing (3). It transfers seeds from the seed hopper (20A) to the tank (8) located at the bottom of the housing (3). During operation of the distribution device (1), the seeds are transported from the tank (8) along a circular path formed by the rotation of the disc (5). A pressure difference (positive or negative) on either side of the disc (5) allows the seeds to be lodged on the drilling holes provided on the disc (5) and be transported to the inlet (10) of the outlet tube (7). The pressure difference can be generated by an air source such as a hydraulically driven turbine mounted on the agricultural machine (2). This air source is then connected to each distribution device (1) via one or more dedicated pipe(s).

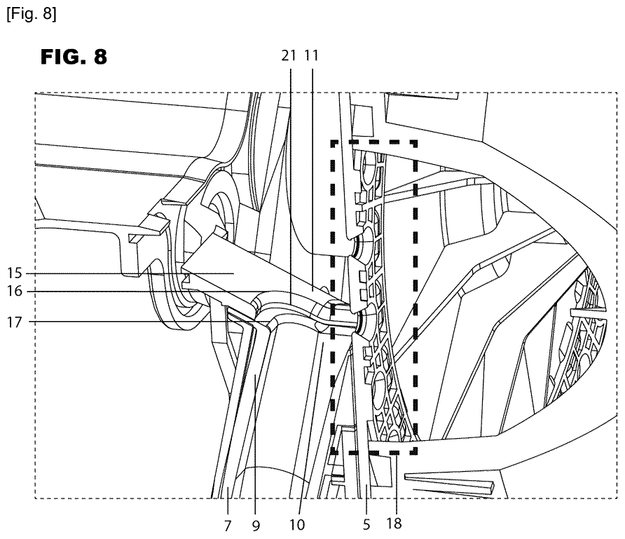

FIG. 8 is a cross-sectional view of the distribution device (1). It enables visualization of the seed transfer stage from the disc (5) to the outlet tube (7). This stage takes place in an outlet region (18) of the distribution device (1). The seeds leave the rotating disc (5) thanks to a pressure difference switching off means (not shown). The switching off means can take the form of a plain wheel mounted in the housing (3) and pressed against the disc (5). The switching off means makes it possible to interrupt the pressure difference between the two sides of the disc (5), and thus to make the seeds fall into the outlet tube (7). Thanks to this switching off means, the seeds always leave the disc (5) at the same point, preferably above the inlet to the outlet tube (7). Other pressure difference switching off means are also possible, such as a skid or a sprocket wheel pressed against the disc (5).

Once the seeds leave the disc (5) after the pressure difference has been interrupted, they return to the outlet tube (7) via its inlet (10). A first portion (9) of the outlet tube (7) is located inside the housing (3) and is oriented so that the inlet (10) is adjacent to the disc (5). The advantage of the position of the inlet (10) relative to the disc (5) is that it ensures efficient transfer of the seeds into the inlet (10), after they have left the disc (5). The closer the inlet (10) of the outlet tube (7) is to the disc (5), the lower the risk of seeds not entering the tube (7) after having left the disc (5). The proximity of the inlet (10) to the disc (5), in particular to the seed ejection point, ensures direct transfer of the seed to the outlet tube (7) and into the furrow, to obtain precise and consistent sowing.

The trajectory and exit speed of the seeds after the disc (5) are crucial to ensure consistent sowing. The location of the inlet (10) of the outlet tube (7) allows better control of the product flow at the outlet of the disc (5). The seeds exiting the disc are channeled into the outlet tube (7) after passing through the inlet (10). The better the control of the product flow, the more consistent and precise the seeding will be, guaranteeing constant seed spacing in the furrow.

According to an important feature of the invention, the distribution device (1) comprises a fairing element (11) in which a first opening (21) extending along a first fairing plane (23) is carried out, and the fairing element (11) at least partially covers the first portion (9) of the outlet tube (7). Thanks to the fairing element (11) which covers the space around the inlet (10), the seeds are guided directly to the outlet tube (7) and consequently, the precision of the sowing operation is ensured. On the other hand, if the seed should not reach the inlet (10) of the outlet tube (7), it would directly return into the tank (8) and be reusable without being damaged. Seeds falling back into the tank (8) are not trapped in a space around the outlet tube (7), as this space is filled by the fairing element (11). The seeds slide easily and unhindered into the tank (8), ensuring that they can be used again later by the distribution device (1). The combination of the location of the inlet (10) of the outlet tube (7) close to the disc (5) and that of the fairing element (11) around the first portion (9) of the outlet tube (7) improves the consistency of the flow of seeds within the distribution device (1).

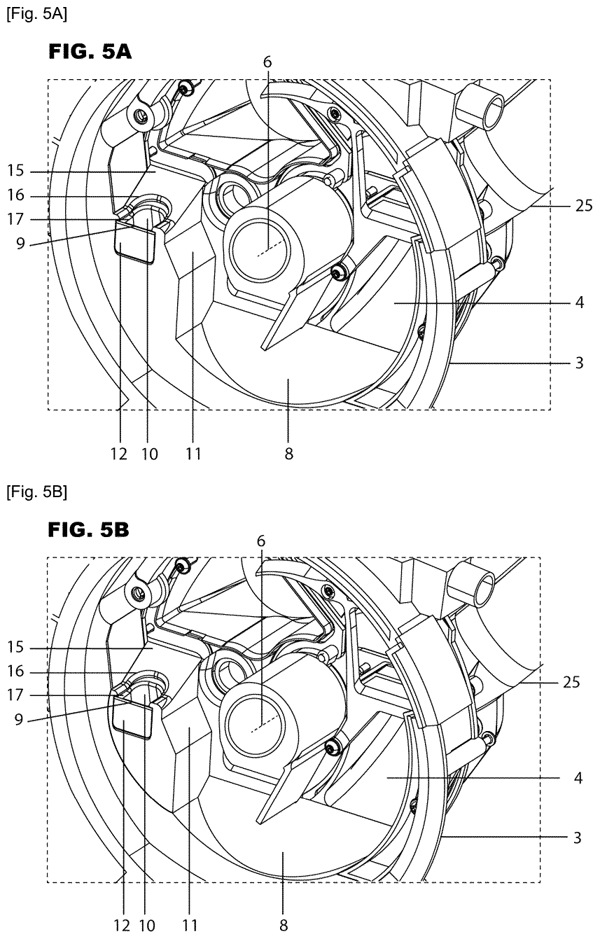

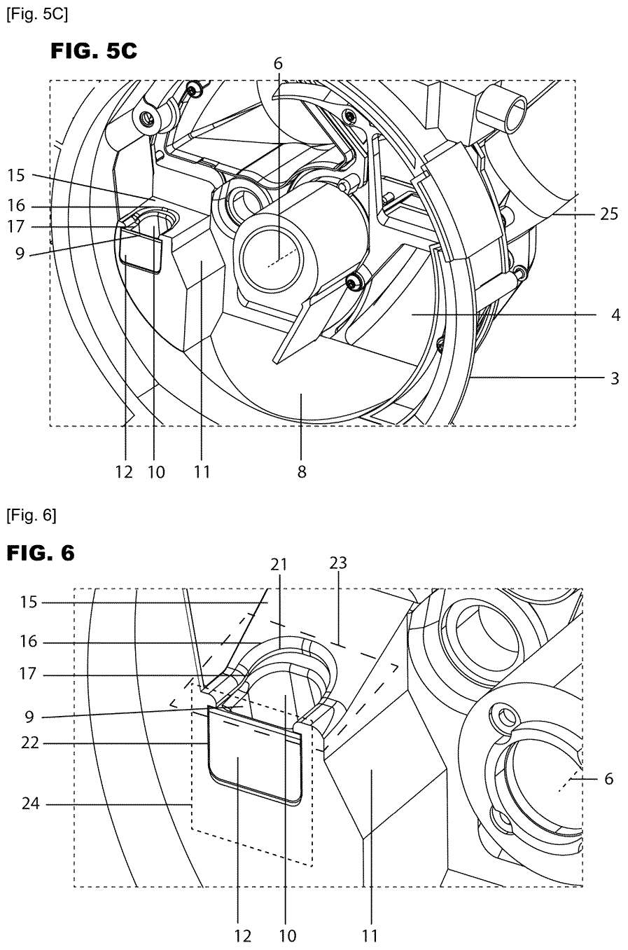

FIG. 5A is a view similar to FIG. 4, but with a different orientation. This figure more specifically illustrates the inner part of the distribution device (1) and in particular the fairing element (11). Thanks to this fairing element (11), the pressure and seed flows inside the housing (3) are better controlled. The fairing element (11) enables the seeds to be guided towards the inlet (10) of the outlet tube (7). In some cases, the fairing element (11) guides the seeds directly to the tank (8), if the seeds do not reach the inlet (10). With the fairing element (11), the seeds are not trapped or damaged, as they are transferred directly to the tank (8). The risk of seeds that cannot reach the inlet (10) being trapped in the housing (3) or damaged is greatly reduced, if not completely eliminated.

FIG. 6 illustrates in greater detail the fairing element (11) that covers the first portion (9) of the outlet tube (7). The fairing element (11) is, for example, a profiled casing designed to cover the first portion (9). A first opening (21) is carried out in the fairing element (11) and oriented along the first fairing plane (23). The first opening (21) is at least aligned with the inlet (10) of the tube (7) and allows seeds to pass into the outlet tube (7), while allowing the fairing element (11) to cover the first portion (9) of the tube (7).

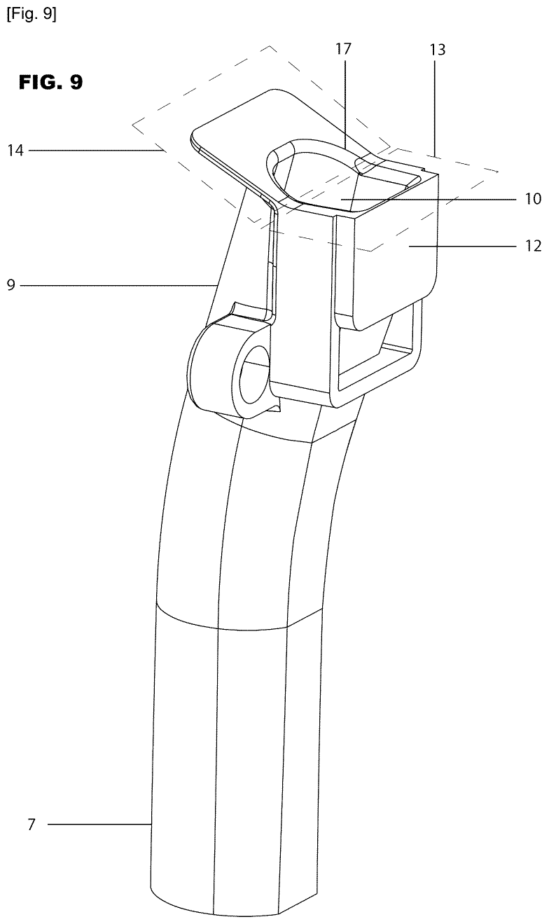

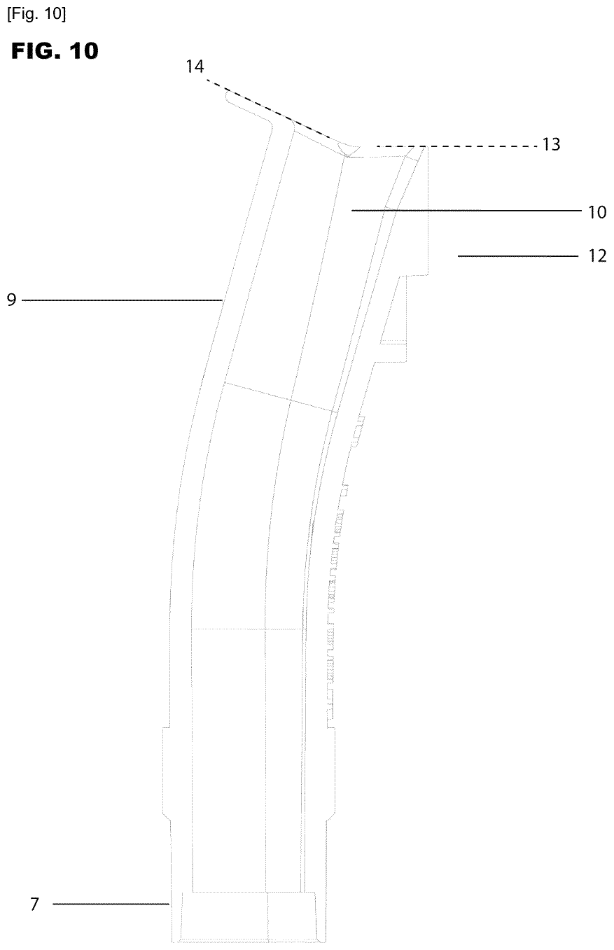

The curvature and general shape of the outlet tube (7) can be seen in detail in FIGS. 9 and 10. The angular orientation of the outlet tube (7) is designed so that seeds entering through the inlet (10) hit the inner wall of the outlet tube (7) the least possible. Limiting the number of bounces as the seeds pass through the outlet tube (7) allows better control over their spacing and consistency as they exit the outlet tube (7) to get into the soil. Similarly, controlling the trajectory of the seeds as they pass through the tube also gives a better idea of their speed during transport. As a result, the upper part of the outlet tube (7) is inclined, both so that the inlet (10) is as close as possible to the disc (5) and to the outlet region (18), and also so that the seeds entering the tube experience as little impact and/or bouncing as possible on their subsequent travel. Advantageously, the inclination of the upper part of the tube (7) is achieved by a curvature with respect to the main axis of the tube (7). Preferably, the angle of this curvature is between 5 and 15° with respect to the main axis of the tube (7). The outlet tube (7) has a generally cylindrical shape, but other profiles (not shown) are possible, for example a triangular shape, to guide the seeds with a chute effect. In the same way, different diameters of outlet tubes (7) are possible, in particular to accommodate variations in seed size depending on the plants and/or varieties to be sown.

The first portion (9) of the outlet tube (7) is located inside the housing (3). The first portion (9) is an integral part of the outlet tube (7), as shown in FIGS. 9 and 10. As shown in FIGS. 5A, 5B, 50, 6 and 8, the fairing element (11) covers the first portion (9) of the outlet tube (7). The advantage of this feature is that it does not let the outlet tube (7) alone, and therefore without a fairing element (11), to protrude inside of the housing (3). This allows the fairing element (11) to guide the pressure and seed flows inside the housing (3), without a protrusion of the outlet tube (7) forming an obstacle. The pressure flows guided by the fairing element (11) are thus free of turbulence due to the shapes of the fairing element (11), which limits the pressurized air consumption of the distribution device (1). Seeds that would not enter the inlet (10) of the outlet tube (7) are guided by the fairing element (11) directly into the tank (8) without being damaged, meaning they can be used again later during the sowing operation.

According to another variant not shown, the outlet tube (7) can be an integral part of the housing (3) and comprise an insert of a similar shape to the first portion (9) of the outlet tube (7) described above, fitted onto the outlet tube (7).

According to another advantageous feature of the invention visible in FIG. 6, the fairing element (11) comprises a second opening (22) extending in a second fairing plane (24), the first fairing plane (23) and the second fairing plane (24) being secant. Preferably, they are oriented at an angle of between 45° and 170°. This angle partly defines the shape of the fairing element. Advantageously, the second fairing plane (24) is substantially parallel to the disc (5). The presence of the second opening (22) oriented along the second fairing plane (24) has the advantage of reducing wear on the fairing element (11) should it come into contact with the rotating disc (5). Reducing wear on the fairing element (11) also makes it possible to reduce the maintenance required on the distribution device (1), which has the advantage of reducing the number, duration, complexity and cost of maintenance operations on the distribution device (1).

A further advantage of the fairing element (11) is that it makes it possible to greatly reduce, or even completely eliminate, some of the turbulence in the pressure flows within the distribution device (1). Thanks to the invention's fairing element (11), the seeds ejected from the disc are guided towards the tube and remain undisturbed. Pressure flows within the distribution device (1), and more particularly around the fairing element (11), have very little or no turbulence, due to the presence of the fairing element (11) around the first portion (9) of the outlet tube (7). This feature makes it possible to reduce the air consumption of the distribution device (1) and, as a result, requires a smaller and therefore less expensive air source (such as a hydraulic turbine).

According to an advantageous feature of the invention visible in FIGS. 4 and 5A, the fairing element (11) is an integral part of the housing (3) of the distribution device (1). In this case, the fairing element (11) is integrated directly into the shape of the housing (3). This feature in particular offers advantages for industrialization, such as limiting the number of components within the distribution device (1) and thus limiting production costs and the number of spare parts to be managed by the manufacturer.

In a further embodiment variant illustrated in FIG. 5B, the fairing element (11) is a separate part of the housing (3) of the distribution device (1), the fairing element (11) preferably being removable from the housing (3). This variant enables the fairing element (11) to be easily disassembled and reassembled as part of a maintenance or cleaning operation on the distribution device (1).

Such a variant also enables the operator to use a fairing element (11) with different shapes and/or features depending on the cases of use for the distribution device (1). Indeed, the different types of agricultural products that can be used have different sizes, profiles and features, and depending on the configuration of the distribution device (1), it may be advantageous to have a fairing element (11) that is wider or narrower, straight or curved, in order to facilitate the flow of seeds around the fairing element (11). This makes it possible to adapt the fairing element (11) to the type of seeds to be distributed, as part of an operation to change the configuration of the distribution device (1). Usually, this operation also involves changing the disc (5) in order to obtain optimum operation of the distribution device (1).

FIGS. 9 and 10 highlight another advantageous feature of the invention, namely that the inlet (10) is oriented in at least two secant planes (13; 14). These two planes (13; 14) are distinct from one another and form an inlet (10) for the outlet tube (7), which accommodates its inclination. These two planes (13; 14) also make it possible to favor the entry of the seeds into the outlet tube (7) compared with an inlet (10) that would be inclined in a single plane. The plane (14), advantageously located higher than the plane (13), makes it possible to effectively channel the seeds which may have an upwardly oriented output trajectory, while the plane (13) enables the inlet (10) to be at closest to the disc (5). Advantageously, the two planes (13; 14) are oriented at an angle of between 120° and 170°, ideally between 150° and 160°. The plane (13) is advantageously substantially horizontal and perpendicular to the disc (5).

According to another advantageous feature of the invention, visible among others in FIGS. 5A, 6 and 8, the fairing element (11) has at least one upper face (15) substantially parallel and/or coplanar with one of the planes (13; 14). This feature enables the fairing element (11) to best match the shapes of the first portion (9) of the outlet tube (7), and in particular the inlet (10). Thus the management of the pressure and seed flows within the distribution device (1) is improved, as described previously.

The upper face (15) of the fairing element (11) makes it possible to guide the seeds towards the inlet (10) of the outlet tube (7). The other faces of the fairing element (11) are oriented to facilitate the discharge of the seeds which have not entered the outlet tube (7) towards the tank (8). As the tank (8) lies lower than the inlet (10) of the outlet tube (7) within the housing (3), the fairing element (11) comprises at least one face oriented substantially vertically to form a discharge boom for the seeds towards the tank (8), in the event that they do not enter the inlet (10).

All or some of the angles between the various faces of the fairing element (11) and the housing (3) are obtuse in order to facilitate the discharge of seeds towards the inlet (10) or towards the tank (8), while avoiding the formation of cavities or recesses where seeds could remain trapped.

All or some of the edges between the various faces of the fairing element (11) may be rounded or have chamfers. Thanks to these rounded edges or chamfers, the seeds pass over the surfaces of the fairing element (11) without impact and more easily, preserving their integrity and preventing damage.

The fairing element (11) can also have different faces to match at best the shapes of the first portion (9) of the outlet tube (7). These faces can be flat, as visible among others in FIGS. 5A, 5B, 6 and 8.

According to a further embodiment variant not shown, some or all of the faces of the fairing element (11) can be curved, to form rounded, concave and/or convex surfaces.

In accordance with a further embodiment variant shown in FIG. 5C, the inlet (10) of the outlet tube (7) may be oriented in a single plane (13). Similarly, according to this variant, the fairing element (11) has an upper face (15) substantially parallel and/or coplanar with the plane (13).

According to another advantageous feature of the invention, visible in particular on FIGS. 5A, 6 and 8, the fairing element (11) has a rounded edge and/or a chamfer (16) adjacent to at least part of the circumference of the inlet (10). This feature makes it possible to facilitate access to the seeds in the inlet (10), while preventing damaging them. Advantageously, the rounded edge and/or chamfer (16) is adjacent to the first opening (21) of the fairing element (11) and is opposite the second opening (22) of the fairing element (11). In this way, the rotation of the disc (5) will not wear away the rounded edge and/or the chamfer (16).

According to another advantageous feature of the invention, visible among others in FIGS. 8 to 10, at least part of the circumference of the inlet (10) of the outlet tube (7) has a rounded edge and/or a chamfer (17). This feature, alone or in combination with the one described in the previous paragraph, also makes it possible to facilitate the access of the seeds in the inlet (10) without damaging them. Advantageously, the rounded edge and/or the chamfer (17) is opposite the side (12) of the first portion (9) of the outlet tube (7). In this way, the rotation of the disc (5) will not wear away the rounded edge and/or the chamfer (17).

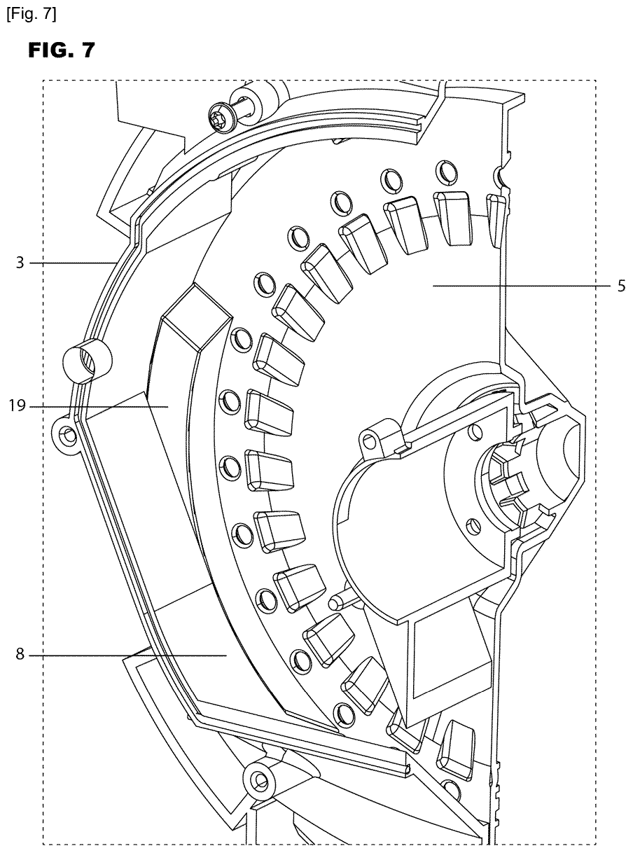

FIG. 7 shows a perspective view of the distribution device (1), with the housing (3) and the disc (5), showing the opposite side of the disc (5), in other words the side where the seeds engage with the drilling holes in the disc (5). The housing (3) includes a blade (19) mounted on or integral with the housing (3). The purpose of the blade (19) is to make it easier to pick up seeds from the disc (5), preventing them from clogging and/or agglomerating on the drilling holes of the disc (5). Here, the blade (19) has an arched shape that gradually approaches the edge of the drilling holes as the circular path of the seeds, and therefore the drilling holes in the rotating disc (5), progresses. Thanks to this particular shape, the blade (19) prevents several seeds from agglomerating on a same drilling hole and forming a duplicate during sowing. Duplicates should be avoided, as they mean that two seeds are in the same position in the furrow at the time of sowing. The blade (19) is located close to the disc (5) or can be in contact with the disc (5) for maximum efficiency. In addition, the blade (19) is positioned so as to start at the seed tank (8), in other words close to the bottom of the housing (3). Advantageously, the blade (19) is positioned so as to start in a lower half of the size of the disc (5). Advantageously, the blade (19) is positioned so as to stop in an upper half of the size of the disc (5). This position and the shape of the blade (19) make it possible to prevent clogging or agglomeration of the seeds together when they are waiting for the disc (5) to rotate in the tank (8) and when they engage with the drilling holes in the disc (5).

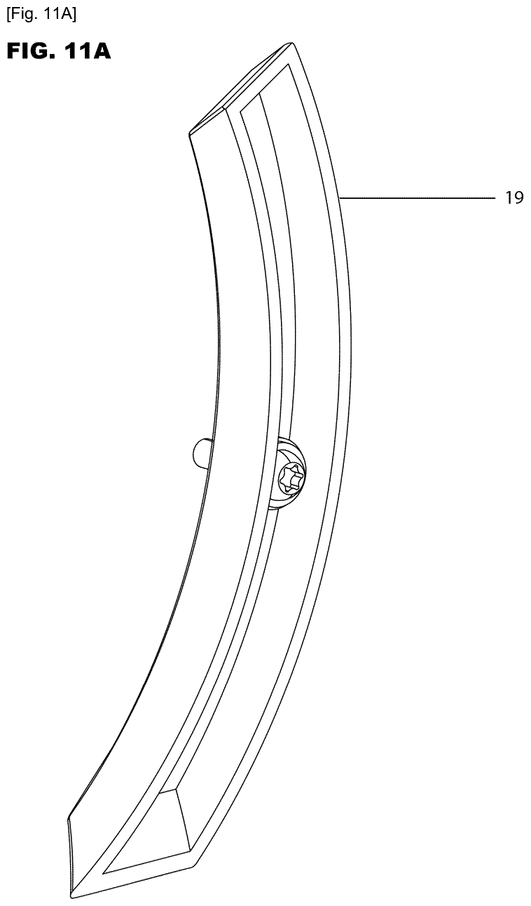

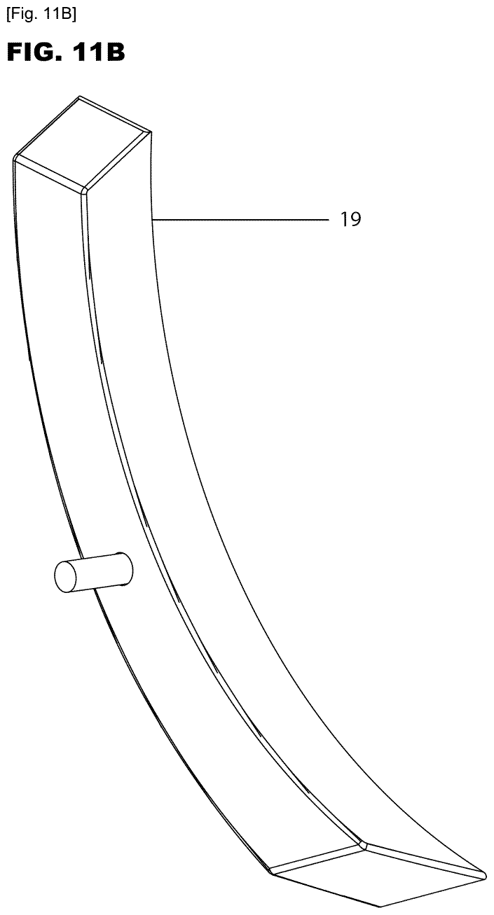

FIGS. 11A and 11B show views of the blade (19) alone, in two orientations. As shown in these figures, the blade (19) can be fitted with at least one removable fastening means, enabling it to be easily disassembled and reassembled in the housing (3). This removable fastening means can be one or more screws and/or one or more fastening clips, as well as other variants known in the field of mechanical construction. A removable fastening means for the blade (19) allows a range of several blades (19), which can be replaced depending on the use of the distribution device (1). Indeed, different types of agricultural products with different features (dimensions, shape, adhesion, etc.) may require adapted blade (19) shapes for optimum efficiency. These adapted shapes are, for example, a greater or lesser radius of curvature of the blade (19), a more or less progressive curvature between its two ends (for example, with a radius of curvature that varies between the two ends), the overall dimensions of the blade (height, width, thickness, etc.), a number of drilling holes of the disc (5) affected by the blade (19) on the circular path of the seeds, etc.

FIG. 12 shows an agricultural machine (2) making it possible to accommodate at least one distribution device (1) with the advantageous features described above. In this case, this is a precision seeder, also known as a single seeder. On FIG. 12 it is a seeder with six seeder elements of the single seeder type. Each seeder element is equipped with at least one distribution device (1) arranged between the seed hopper and soil-working and/or sowing elements which are in contact with the ground.

Obviously, the invention is not limited to the embodiments described and shown in the attached drawings. Modifications remain possible, in particular as regards the composition of the various elements or the substitution by technical equivalents without departing from the scope of protection of the invention.

1. A seed distribution device for an agricultural machine such as a single seeder, the distribution device comprising a housing, a seed inlet arranged in the housing, a perforated disc driven to transport the seeds along a circular path, an outlet tube transporting the seeds from the housing to a furrow in a plot of land, the seeds being transported from a tank located in the housing towards the outlet tube by means of an air pressure difference on either side of the disc, the air pressure difference being interrupted in an outlet region close to the outlet tube, so that the seeds leave the disc to reach the outlet tube, the outlet tube comprising a first portion into which the seeds enter via an inlet, this first portion of the outlet tube being located inside the housing and being oriented so that the inlet is adjacent to the disc, wherein the distribution device comprises a fairing element in which a first opening extending along a first fairing plane is carried out, and in that the fairing element at least partially covers the first portion of the outlet tube.

2. The distribution device according to claim 1, wherein the fairing element comprises a second opening extending in a second fairing plane, the first fairing plane and the second fairing plane being secant.

3. The distribution device according to claim 1, wherein the fairing element is an integral part of the housing of the distribution device.

4. The distribution device according to claim 1, wherein the fairing element is a separate part of the housing of the distribution device, the fairing element preferably being removable from the housing.

5. The distribution device according to claim 1, wherein the inlet is oriented along at least two secant planes.

6. The distribution device according to claim 5, wherein the fairing element has at least one upper face substantially parallel and/or coplanar with one of the planes.

7. The distribution device according to claim 1, wherein the fairing element has a rounded edge and/or a chamfer adjacent to at least part of the circumference of the inlet.

8. The distribution device according to claim 1, wherein at least part of the circumference of the inlet of the outlet tube has a rounded edge and/or a chamfer.

9. An agricultural machine comprising a distribution device according to claim 1.
